(19) United States
(12) Patent Application Publication
(10) Pub. No.: US 2022/0138747 A1
(43) Pub. Date: May 5, 2022

(54) Round trip resource sharing method with time slot locking

(71) Applicant: Yomangjin company, Jeju-si (KR)

(72) Inventors: Chan Woo KIM, Daejeon (KR); Bonggin KIM, Jeju-si (KR)

(73) Assignee: Yomangjin company, Jeju-si (KR)

(21) Appl. No.: 17/175,866

(22) Filed: Feb. 15, 2021

(30) Foreign Application Priority Data
Oct. 30, 2020 (KR) 10-2020-0143139

(51) Int. Cl. G06Q 20/40; H04L 9/32; H04L 9/06; H04L 9/30

(52) U.S. Cl. CPC G06Q 20/401; H04L 9/3247; H04L 9/3263; H04L 2209/56; H04L 9/30; G06Q 2220/00; H04L 9/0643

(57) ABSTRACT

A round trip resource sharing method and system with time slot locking is disclosed. The method may include issuing a time slot-based owner certificate and an owner resource profile through a shared resource transaction system; setting a shared resource to a time slot authentication and authorization device with the owner certificate and resource profile; disclosing the set shared resource to the transaction system; setting a lessee certificate and a lessee resource profile of a lessee who concluded a transaction to the time slot authentication and authorization device; using, by the lessee, the shared resource through the time slot authentication and authorization device or disclosing the shared resource to the transaction system for resale permitted by the owner.

### CROSS-REFERENCE TO RELATED APPLICATION

This application claims priority to and the benefit of Korean Patent Application No. 10-2020-0143139, filed on Oct. 30, 2020, the disclosure of which is incorporated herein by reference in its entirety.

### TECHNICAL FIELD

The present invention relates to a round trip resource sharing method using time slot locking.

### BACKGROUND

A resource sharing method is utilized as an important means for using resources in a sharing platform. As an example of a resource sharing method technology, Korean Patent Laid-Open No. 10-2020-0004716 (published on Jan. 14, 2020) describes a vehicle sharing service device and an operating method thereof which provides an environment capable of recommending public use of shared vehicles to each specified subject by specifying the subject requiring a vehicle sharing service to secure convenience in using a vehicle sharing service and simultaneously increase service participation.

The resource sharing method can be defined as an important technical means of providing reliability between owners and lessees in sharing platforms and sharing economy services.

The resource sharing method should allow the owner and lessee to control the use of the resource under mutually agreed terms of use for the resource.

The currently released resource sharing method is provided by attaching a sharing service device to the resource and controlling the sharing service device.

However, such a sharing service device involves a change in a resource to be shared and is made in the form of semi-permanently attaching the device to the resource to be shared so that a number of unspecified people cannot separate the device, and a considerable amount of goods is required for this.

In addition, it involves connecting to the network using a method of centrally controlling the sharing service device, and due to the cost of manufacturing and attaching the sharing service device used in the sharing economy service, currently released sharing platform services are often provided by investing a large amount of capital.

In the present invention, resource sharing is provided through a time slot-based locking that can be operated even in an environment without central control and network connection, and a differentiated technology is proposed in that the lessee cannot access the resource fundamentally after a given time.

The above information disclosed in this Background section is only for enhancement of understanding of the background of the invention and it may therefore contain information that does not form the prior art that is already known to a person of ordinary skill in the art.

### SUMMARY

The present invention is directed to providing a method that ensures economic feasibility, convenience, sharing safety, and security through a round trip resource sharing with time slot locking to overcome the limitations of the conventional resource sharing method which uses a method of centrally controlling.

Time slot is a variable time unit, and a time measurement unit for sharing that is individually created for each shared resource. A resource owner may share the resource with others by designating a target time slot to share.

The present invention is directed to providing a method in which a resource owner may safely deliver a shared resource to another person for a designated time slot, and a recipient may freely use or resell for a permitted time slot within the conditions set by the previous owner.

In addition, the present invention is directed to providing a method in which when a period of use designated by a resource owner has expired, only the resource owner can access the resource.

A round trip resource sharing method with time slot locking according to an embodiment of the present invention may include issuing an owner certificate that proves ownership of a resource from a shared resource transaction system; generating, by an owner, a sharing target resource profile that lists shared processing attribute data items including the size of a time slot that for the shared resource sets a sharing method, a sharing period of time, and a minimum sharing time unit; generating, by the owner, a time slot based on the resource profile; disclosing, by the owner, a generated owner certificate, resource profile, and shared time slots of the shared resource to a shared resource transaction system; searching for, by a lessee, the resource profile and shared time slot; verifying, by the lessee, the owner certificate and shared time slot to verify the safety of the shared resource transaction; issuing or renewing, by the lessee, a lessee certificate from the shared resource transaction system depending on his/her initial transaction or the expiration of the certificate term of validity; digitally signing, by the lessee, a share-use time slot share request (including the owner certificate, resource profile, and purchase target time slots) using the lessee certificate for charged or free, and then generating a shared resource right of use certificate and a time slot right of use; receiving, by the lessee, the shared resource by electronic means using the shared resource right of use certificate and the time slot right of use; repeating, by the lessee, opening and locking the time slot of the shared resource by electronic means using the time slot right of use; electronically blocking access of the lessee after a specified time; if the owner permits resale to the lessee, generating a sharing target resource profile for resale that lists shared processing attribute data items including the size of a time slot for resale that sets a sharing method, a sharing period of time, and a minimum sharing time unit, based on the time slot right of use held, with the same method as the owner to the extent not exceeding the range specified in the owner's shared resource profile; generating, by the lessee, a time slot based on the resource profile for resale; and disclosing, by the lessee, the generated owner certificate, resource profile, and shared time slots of the shared resource to the shared resource transaction system.

Specifically, the owner certificate for the shared resource is may verify the identity of the resource owner by generating and issuing based on a universal certificate widely used in electronic transactions such as a digital signature act, and a self-authentication widely used such as a mobile phone. In addition, it may include use of public key encryption and symmetric key encryption used for digital signature, and hash functions, and use a combination of multi-factor authentication such as biometric authentication that activates a private key of a digital signature in combination with a digital signature. The technical elements related to the certificate are excluded from the scope of the claims, and they are elements to secure compatibility and reliability by complying with the X.509 ITU-T international standard (Information technology—Open Systems Interconnection—The Directory: Public-key and attribute certificate frameworks).

Specifically, the data attributes described in the sharing target resource profile may include whether the owner permits resale of shared resource by lessees, and designation of the number of resales permitted in the sharing target resource profile. The owner may determine whether or not to permit resale by the lessee in setting the shared resource sharing method, and set unlimited or whether or not to limit the number of times if resale is permitted, and in the case of a sharing period of time, a plurality of sharing periods of time may be included in the sharing target resource profile by setting one or more sharing periods of time for one resource. The time slot in which the owner sets the minimum sharing time unit may be designated as a rational number including an integer based on various time units such as year, month, day, hour, minute, and second.

Specifically, as for the data attribute described in the sharing target resource profile, the time index precision time slot may be designated as a rational number including an integer based on various time units such as year, month, day, hour, minute, and second.

Specifically, the data attribute described in the sharing target resource profile may be included in the sharing target resource profile by specifying the attributes of resources to be managed through resource sharing. For example, in the case of a vehicle, attributes of resources to be consumed or managed due to resource sharing, such as fuel amount, mileage, and whether or not an accident has occurred, may be defined according to resource characteristics and included in the sharing target resource profile.

Specifically, the sharing target resource profile is an electronic document defining data for sharing resources, and in order to have effect, at the time the initial creation is finished, the shared resource transaction system generates a hash value by executing a hash function having as inputs information extracted in a form difficult to guess from part of information on a sharing target resource profile and standard time and specific information unique to the owner, and then encrypts it with the owner's private key to generate a digital signature value and store it in the shared resource transaction system, and the digital signature value includes a term of validity, and the term of validity is set equal to the end period of the sharing period of time. The owner cannot deny the creation of the sharing target resource profile due to the digital signature value, and may verify whether the sharing target resource profile is forged or altered through the digital signature value stored in the shared resource transaction system based on the principle of public key encryption. If the owner wants to extend the sharing period additionally and it is not disclosed to a third party in the shared resource transaction system, the sharing period can be changed and the digital signature value can be regenerated, but if it is disclosed to the third party, the sharing period cannot be changed, and a procedure for creating a new shared transaction must be followed.

Specifically, the digital signature of the sharing target resource profile may include a combination of a digital signature value obtained by encrypting the original text of the sharing target resource profile, the result of a hash function for the original text with the private key of the resource owner, and a resource owner certificate. A third party participating in the shared resource transaction may verify the identity of the owner of the resource through the resource owner's certificate included in the digital signature, and to verify whether the sharing target resource profile is forged or altered, the value generated by decrypting the digital signature value with the public key of the resource owner disclosed in the shared resource transaction system and the result of the hash function of the sharing target resource profile are compared to determine whether they match, and if they do not match, it can be detected as forged or altered.

Specifically, the creation of a time slot is performed through the shared resource transaction system with the minimum sharing time unit defined in the sharing target resource profile, every time slot has data items for receiving, returning, and using resources such as a unique identifier, previous time slot identifier, start time index, end time index, whether the resource is received, whether the resource is returned, whether the resource is locked, the number of locks, the number of openings, the owner's time slot signature value. For example, if the sharing period of time is 1 hour and the size of the time slot is 10 minutes, a total of 6 time slots can be created, and each of the 6 time slots created has a unique identifier and data item.

Specifically, the start time index and end time index are values set to a natural number set to 10 times or more of the time slot size, and are time units used to determine whether the lessee's sharing actions such as receiving, returning, locking and opening the resources of the corresponding time slot are possible. For example, if the time slot is set to 10 minutes, the start time index is 0 and the end time index is assigned a natural number of 100.

Specifically, disclosing the owner certificate, resource profile, and shared time slots of the shared resource created by the owner on a shared transaction system refers to disclosing the owner certificate, the resource profile, and the shared time slot on various types of shared transaction systems such as centralized or distributed server method and peer-to-peer method, and the lessee may access the disclosed information through the shared transaction system.

Specifically, verifying, by the lessee, the owner certificate and shared time slot to verify the safety of the shared resource transaction refers to first verifying the authenticity of the owner certificate in the X.509 method, and may include internally activating a private key stored in advance by biometric authentication in a trust zone, and verification is provided through the shared resource transaction system. Only if the owner certificate is normal, it is possible to verify the digital signature value of the sharing target resource profile and the digital signature value of the shared time slot to be used for the shared transaction. Such verification of digital signatures essentially includes the validation of the time slot based on the standard time, and due to the nature of resource sharing, a shared transaction may not be established without the premise that all owners and sharers participating in the transaction access it based on standard time. However, it is not premised that the standard time is always accessed online, and a shared transaction may be established, including all cases in which the standard time is used by using a time measuring device that is synchronized with the standard time at the start of the transaction.

Specifically, issuing a certificate by a lessee for a shared transaction is an action to establish the reliability and accountability of the rental doer who is a party to the shared transaction, and is performed through the shared resource transaction system in compliance with the X.509 standard. Such an issuing action of a lessee occurs at the time of initial transaction, at the time of loss of the certificate, and at the time of expiration of the term of validity, and the term of validity complies with the standard recommendations. Since issuing a certificate by the lessee is performed in compliance with the standard, it is excluded from the scope of patent claims.

Specifically, renewing a certificate by the lessee for a shared transaction is an action to renew the term of the certificate as the term of validity has reached the expiration point, and is performed through the shared resource transaction system in compliance with the X.509 standard. Renewing a certificate by the lessee is performed in compliance with the standard.

Specifically, generating a shared resource right of use certificate by a lessee is transacted for charged or free according to a shared resource profile set by an owner or a lessee who resells, and the lessee may request a share-use time slot purchase request from the shared resource transaction system by selecting at least one target time slot to share. The purchase request contains information necessary for sharing such as an owner certificate, a sharing target resource profile, one or more purchase target time slots, amount of payment, payment method, transaction request time, transaction cancellation available time point, and refund policy. The shared resource transaction system generates a hash value by executing a hash function having as inputs information extracted in a form difficult to guess from part of information on a share request and standard time and specific information unique to the sharer, and then encrypts it with the lessee's private key to generate a digital signature. In addition, to secure the safety of shared transactions and respond to third parties, the system generates a hash value by executing a hash function having as inputs a share request original text, a lessee certificate, a lessee's digital signature value and standard time, and then encrypts it with the shared resource transaction system's private key to generate a digital signature for a shared resource right of use certificate.

Specifically, the lessee's shared resource right of use certificate may include the share request original text, the lessee certificate, the lessee's digital signature value, and the shared resource transaction system's private key, may take a double signature method to detect forgery and alteration, and may verify the content of the transaction to have resistance to third parties.

Specifically, generating the time slot right of use by the lessee refers to generating for each sharing target time slot after generating the shared resource right of use certificate by the lessee, so it can be generated limited only for the time slot specified in the shared resource right of use certificate. The time slot right of use performs double digital signature for the safety of the shared transaction, generating a time slot digital signature value encrypted with the lessee's private key for the shared time slot and a double time slot digital signature value for which the time slot digital signature value is encrypted once more with the shared resource transaction system's private key.

Specifically, the time slot right of use owned by the lessee is a combination of data composed of several items, and includes the owner certificate, the share resource profile, the time slot, the lessee certificate, the lessee's time slot signature value, and the double time slot digital signature value.

According to an embodiment of the present invention, it is possible to implement limited resource sharing for a predetermined period through the round trip resource sharing with time slot locking and ensure that the owner can only recover the returned resource.

According to an embodiment of the present invention, even when a resource cannot be centrally controlled in a communication network, through time slot locking using a control device embedded in the resource, it is possible to guarantee stable use of the shared resource by the lessee and discontinuation of use after the rental period of time.

The present invention can improve economic feasibility, convenience, sharing safety, and security in that it guarantees service continuity in a communication shadow area of shared resources, and requires limited communication and setting at the time of rental and return.

According to an embodiment of the present invention, a method for a resource owner to permit resale and a method for a lessee to resell through the system are provided.

### BRIEF DESCRIPTION OF THE DRAWINGS

The above and other aspects, features, and advantages of the present invention will become more apparent to those of ordinary skill in the art by describing embodiments thereof in detail with reference to the accompanying drawings, in which:

FIG. 1 is a diagram illustrating a round trip resource sharing system with time slot locking according to an exemplary embodiment of the present invention;

FIG. 2 is a flowchart illustrating a round trip resource sharing method with time slot locking according to an exemplary embodiment of the present invention.

### DESCRIPTION OF SYMBOLS

102: time slot-based shared resource transaction system
104: time slot-based owner certificate
106: owner resource profile
108: time slot-based lessee certificate
110: time slot right of use
112: time slot authentication and authorization device
114: physical locking device
116: lessee resource profile

### DETAILED DESCRIPTION OF THE EMBODIMENTS

Hereinafter, the embodiments of the present invention are described in detail with reference to the accompanying drawings.

The embodiments of the present invention can be used in various fields requiring rental and return of resources by using a resource sharing method with time slot locking.

In this specification, it is described as applying time slot locking to resource sharing, but is not limited thereto, and of course can be applied to transactions of all resources contended by a large number such as a transaction system based on time slot locking.

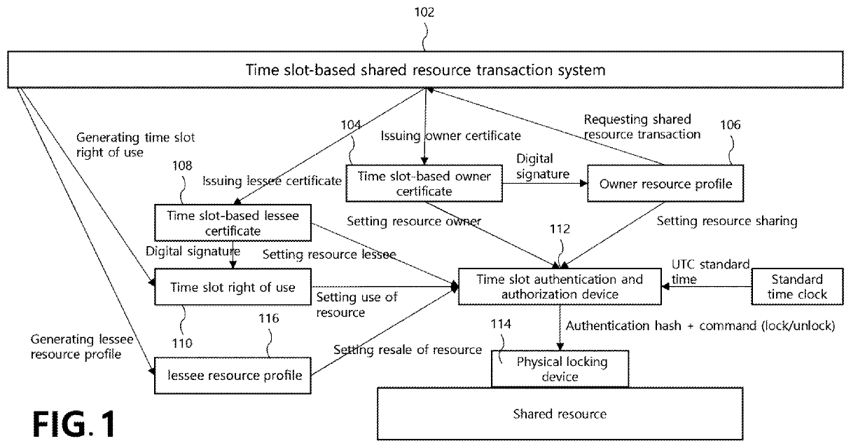

FIG. 1 is a diagram illustrating a round trip resource sharing system with time slot locking according to an exemplary embodiment of the present invention.

Referring to FIG. 1, a shared resource transaction system according to the present invention may include a time slot-based shared resource transaction system 102, a time slot-based owner certificate 104, an owner resource profile 106, a time slot-based lessee certificate 108, a time slot right of use 110, a time slot authentication and authorization device 112, a physical locking device 114, and a lessee resource profile 116. In addition, it is premised that the standard time clock or timer is used.

The time slot-based shared resource transaction system 102 may simultaneously register and disclose an owner resource profile including detailed terms and conditions of transaction such as specifications of the resource that the owner wants to lease for a certain period of time, rental period and whether or not to permit resale, and a lessor may search and compare the specifications of the resource and the terms and conditions of transaction and provide them to enter into a lease. The time slot-based shared resource transaction system 102 may sell or lend the time slot authentication and authorization device 112 and the physical locking device 114 required for a shared resource transaction at a certain price to the owner of the shared resource, and provide a service for charged or free so that these devices can be safely mounted on shared resources.

In the above, the owner and the lessor refer to the owner's terminal and the lessor's terminal.

The time slot-based owner certificate 104 is to prove and verify the identity of the resource owner by generating and issuing based on a universal certificate widely used in electronic transactions such as a digital signature act, and a self-authentication widely used such as a mobile phone. The time slot-based owner certificate 104 includes use of public key encryption and symmetric key encryption used for digital signature, and hash functions, and uses a combination of multi-factor authentication such as biometric authentication that activates a private key of a digital signature in combination with a digital signature. The technical elements related to the time slot-based owner certificate (104) are excluded from the scope of the claims, and they are used as elements to secure compatibility and reliability by complying with the X.509 ITU-T international standard (Information technology—Open Systems Interconnection—The Directory: Public-key and attribute certificate frameworks).

The owner resource profile 106 includes data attributes required for a shared resource transaction, such as a sharing period of time, a size of a time slot, a sharing cost per time slot, whether the owner permits resale of a shared resource by lessees, and designation of the number of resales permitted.

By describing the data attribute in the owner resource profile 106, the owner may determine whether or not to permit resale by the lessee, and set unlimited or whether or not to limit the number of times if resale is permitted. Among the data attributes, essential attributes should have a sharing period of time and a size of time slot, and a plurality of sharing periods of time may be included in a sharing target resource profile. In addition, the time slot may be designated as a rational number including an integer based on various time units such as year, month, day, hour, minute, and second. The owner resource profile 106 may specify the attributes of resources to be managed through resource sharing and include them in a sharing target resource profile, and define the attributes of resources to be consumed or managed due to resource sharing according to resource characteristic and include them in the sharing target resource profile. For example, in the case of a vehicle, resource attributes such as fuel amount, mileage, whether an accident has occurred, and whether the vehicle is washed may be specified.

The owner resource profile 106 is an electronic document defining data for sharing resources, and in order to have effect, at the time the initial creation is finished, the shared resource transaction system generates a hash value by executing a hash function having as inputs information extracted in a form difficult to guess from part of information on a sharing target resource profile and standard time and specific information unique to the owner.

Then, it is encrypted with the owner's private key, and a digital signature value is generated and stored in the shared resource transaction system, and the digital signature value includes a term of validity, and the term of validity is set equal to the end period of the sharing period of time. The owner resource profile 106 cannot deny the owner's creation of the sharing target resource profile due to the digital signature value, and whether forged or altered may be verified through the digital signature value stored in the shared resource transaction system based on the principle of public key encryption.

The digital signature of the owner resource profile 106 includes a combination of a digital signature value obtained by encrypting the original text of the sharing target resource profile, the result of a hash function for the original text with the private key of the resource owner, and a resource owner certificate. A third party participating in the shared resource transaction may verify the identity of the owner of the resource through the resource owner's certificate included in the digital signature of the owner resource profile 106. To verify whether the sharing target resource profile is forged or altered, the value generated by decrypting the digital signature value with the public key of the resource owner disclosed in the shared resource transaction system and the result of the hash function of the sharing target resource profile are compared to determine whether they match, and if they do not match, it can be detected as forged or altered.

The time slot-based lessee certificate 108 is to prove the identity of a lessee, and has the same function as the time slot-based lessee certificate 104, and technical elements similarly related to the owner certificate 104 are excluded from the scope of the claims.

The lessee resource profile 116 is functionally the same as the owner resource profile 106, but differs in that a rental period of time of the shared resource for the lessee is set. If the owner permits the resale of the rental resource, the owner resource profile 106 operates in the same manner, and the corresponding resource and time slot are accumulated and managed and disclosed in a stack method through the time slot-based shared resource transaction system 102, thereby making sure anybody knows that it's a reselling resource.

The time slot authentication and authorization device 112 provides an owner setting, a setting for sharing resources, a lessee authentication, a time slot right of use authorization, a setting for resale by a lessee, and a resource recovery function by the owner, and has two statuses of ‘unset’ and ‘set’ for internal status values. In addition, the time slot authentication and authorization device 112 embeds the accredited certificate of the time slot-based shared resource transaction system 102 from the time of manufacture.

The owner setting of the time slot authentication and authorization device 112 may be performed if the internal status value is unset, and if unset, the time slot-based owner certificate 104 may be set only in case the owner correctly inputs the activation code received from the time slot-based shared resource transaction system 102. The owner setting is stored in the time slot authentication and authorization device 112 after receiving the time slot-based owner certificate 104 through wired or wireless communication means, and then using the embedded accredited certificate of the time slot-based shared resource transaction system 102 to verify whether the certificate is normal or not.

The setting for sharing resources of the time slot authentication and authorization device 112 is performed when the digitally signed owner resource profile 106 is input, and the setting is processed after verification based on the owner certificate. The setting for sharing resources includes the creation of a time slot, and with the minimum sharing time unit defined in the sharing target resource profile, every time slot has data items for receiving, returning, and using resources such as a unique identifier, previous time slot identifier, start time index, end time index, whether the resource is received, whether the resource is returned, whether the resource is locked, the number of locks, the number of openings, the owner's time slot signature value. For example, if the sharing period of time is 1 hour and the size of the time slot is 10 minutes, a total of 6 time slots can be created, and each of the 6 time slots created has a unique identifier and data item. The start time index and end time index are values set to a natural number set to 10 times or more of the time slot size, and are time units used to determine whether the lessee's sharing actions such as receiving, returning, locking and opening the resources of the corresponding time slot are possible. For example, if the time slot is set to 10 minutes, the start time index is 0 and the end time index is assigned a natural number of 100.

After completing the setting for sharing resources of the time slot authentication and authorization device 112, the internal status value is changed to ‘set’, and disclosing the owner certificate, resource profile, and shared time slots of the shared resource created by the owner on a shared transaction system refers to disclosing the owner certificate, the resource profile, and the shared time slot on various types of shared transaction systems such as centralized or distributed server method and peer-to-peer method, and the lessee may access the disclosed information through the shared transaction system.

The lessee authentication of the time slot authentication and authorization device 112 is stored as a lessee certificate in the time slot authentication and authorization device 112 after receiving the lessee certificate through wired or wireless communication means, and then using the embedded accredited certificate of the time slot-based shared resource transaction system 102 to verify whether the certificate is normal or not.

After receiving the lessee's time slot right of use through wired or wireless communication means, and then using the embedded accredited certificate and lessee certificate of the time slot-based shared resource transaction system 102 to verify whether the time slot right of use is normal or not, the lessee's time slot right of use authorization of the time slot authentication and authorization device 112 authorizes that a right to control of the physical locking device 114 may be used.

After verifying whether resale is permitted and the allowable range of the resale setting in the owner resource profile 106, if there is no abnormality, the setting for resale by a lessee of the time slot authentication and authorization device 112 is performed, and the process is the same as the process of the setting for sharing resources of the time slot authentication and authorization device 112. In this case, the setting of the lessee resource profile 116 is finally applied to the resource sharing setting, and the lessee may disclose the lessee resource profile 116 to the time slot-based shared resource transaction system 102 with the same authority as the owner during the period of time for which the rental is permitted.

The resource recovery function by the owner of the time slot authentication and authorization device 112 automatically recovers the authorized authority of the expired time slot of the lessee by a timer event operating internally. However, if the shared resource is movable and only in case immediate resource recovery causes a safety accident, the resource is recovered after sufficient notice is repeated before the expiration of the time slot.

The physical locking device 114 is a device that is physically attached to the sharing target resource of the owner and is connected to the time slot authentication and authorization device 112 to provide resource use and status service such as locking and opening of resources and displaying resource status.

The physical locking device 114 has an interface including at least 128 pins in a dense form to prevent illegal exposure of a control line connected to the resource to control the resource. The physical locking device 114 may be divided into a resource internal attachment part and a resource external attachment part, and the resource internal attachment part may include a protection device that cannot see how the function of the circuit is connected to the at least 128 pins. The resource internal attachment part is designed to prevent illegal use of the resource by being damaged when it is damaged in order to infer the connection and method. As an example of such a protection device, there is an example of the construction of a compound used in an aircraft circuit, and the circuit is also damaged along with the breakage of the protection device. Since the protection device is a widely used method, it is not included in the scope of patent claims.

The external attachment part of the physical locking device 114 connects the internal attachment part through an interface having at least 128 pins in a dense form with the same type of interface as the time slot authentication and authorization device 112. These interfaces include control lines and power lines together.

The lessee resource profile 116 is functionally the same as the owner resource profile 106, but differs in that a rental period of time of the shared resource for the lessee is set. If the owner permits the resale of the rental resource, the owner resource profile 106 operates in the same manner, and the corresponding resource and time slot are accumulated and managed and disclosed in a stack method through the time slot-based shared resource transaction system 102, thereby making sure anybody knows that it's a reselling resource.

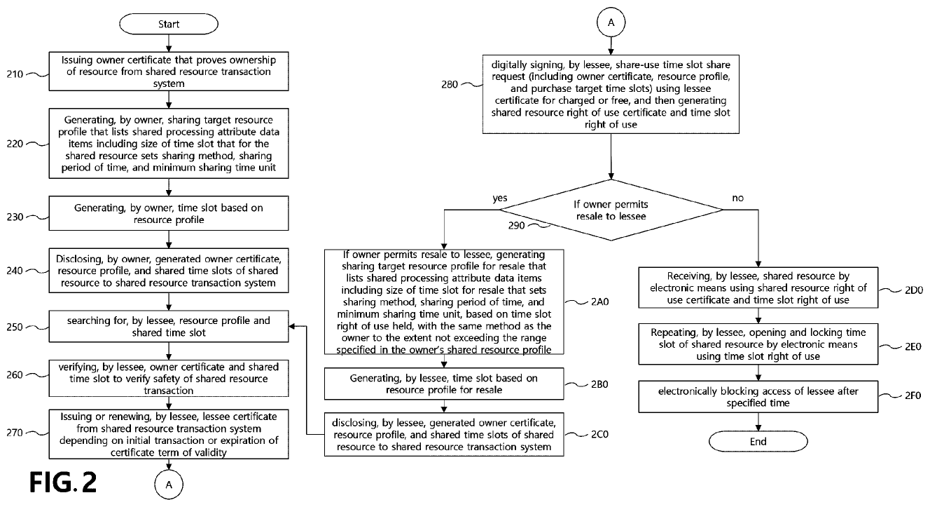

FIG. 2 is a flowchart illustrating a round trip resource sharing method with time slot locking according to an exemplary embodiment of the present invention. In a round trip resource sharing method with time slot locking according to an embodiment of the present invention, each step may be performed by the authentication system described with reference to FIG. 1.

In step 210, from the time slot-based shared resource transaction system, a unique certificate is issued for a shared resource after passing through a verification process prior to a normal shared resource registration transaction, such as user registration and verification of authenticity of the resource. The issued time slot-based owner certificate 104 is stored in the time slot-based shared resource transaction system 102, and may be issued to the shared resource owner and be downloadable as a physical file.

In step 220, the owner generates a sharing target resource profile that lists shared processing attribute data items including the size of a time slot that for the shared resource sets a sharing method, a sharing period of time, and a minimum sharing time unit in the time slot-based shared resource transaction system 102.

In step 230, the owner transmits the time slot-based owner certificate 104 and owner resource profile 106 issued from the time slot-based shared resource transaction system 102 to the time slot authentication and authorization device 112 through wired or wireless communication to create a time slot. In this process, the time slot authentication and authorization device 112 verifies and sets the time slot-based owner certificate 104 and the owner resource profile 106.

In step 240, the owner discloses the generated owner certificate, resource profile, and shared time slots of the shared resource to the time slot-based shared resource transaction system 102.

In step 250, a lessee searches for the disclosed resource profile and shared time slot in the time slot-based shared resource transaction system 102.

In step 260, the lessee verifies the owner certificate and shared time slot to verify the safety of the shared resource transaction in the time slot-based shared resource transaction system 102.

In step 270, the lessee proves his/her identity in order to lease the shared resource, and issues or renews a lessee certificate from the time slot-based shared resource transaction system 102 depending on his/her initial transaction or the expiration of the certificate term of validity. If the lessee has already obtained the time slot-based lessee certificate 108 from the time slot-based shared resource transaction system 102 and the corresponding certificate is valid, this step may be omitted.

In step 280, the lessee digitally signs a share-use time slot share request (including the owner certificate, resource profile, purchase target time slots, etc.) using the lessee certificate for charged or free in the time slot-based shared resource transaction system 102, and then generates a shared resource right of use certificate and a time slot right of use.

In step 290, the time slot-based shared resource transaction system 102 determines whether the owner permits resale and whether the lessee is willing to resell, and only if the owner permits resale and the lessee indicates an intention to resell, may proceed to step 2A0.

In step 2A0, if the owner permits resale to the lessee, the lessee generates a lessee resource profile 116 for resale that lists shared processing attribute data items including the size of a time slot for resale that sets a sharing method, a sharing period of time, and a minimum sharing time unit, based on the time slot right of use held, with the same method as the owner to the extent not exceeding the range specified in the owner's shared resource profile.

In step 2B0, the lessee generates a time slot based on the resource profile for resale in the time slot-based shared resource transaction system 102. In this step, the lessee's generation of the time slot in the time slot authentication and authorization device 112 is not applied, and this step is delayed and performed at the time of actual use.

In step 2C0, the lessee discloses the generated time slot-based lessee certificate, lessee resource profile 116d, and shared time slots for resale to the time slot-based shared resource transaction system 102.

In step 2D0, the lessee receives the shared resource by electronic means using the time slot-based lessee certificate 108 and the time slot right of use 110 which are issued as the shared resource right of use certificate. However, in the case of rental by resale, the lessee additionally receives the time slot-based lessee certificate 108 and the lessee resource profile 116 by electronic means. Here, the electronic means refers to accessing the time slot-based shared resource transaction system 102 from a mobile terminal owned by the lessee by using an electronic means such as a smart app. The time slot-based lessee certificate 108 is a certificate for each resource that is issued to a final lessee who has completed a transaction by performing, in the time slot-based shared resource transaction system 102, final verification for the owner of the shared resource that is the basis of the transaction or the lessee who has performed resale, the term of validity being limited to the period of use for the corresponding resource.

In step 2E0, adjacent to the shared resource to be used, the lessee may repeat the control of the shared resource such as opening and locking the time slot of the shared resource through the time slot authentication and authorization device 112 by electronic means using the time slot-based lessee certificate 108 and the time slot right of use 110, if resold, the time slot-based lessee certificate 108 and the lessee resource profile 116. Here, the electronic means is the same as the electronic means applied in step 2D0.

In step 2E0, the time slot authentication and authorization device 112 verifies the digital signature of the time slot-based lessee certificate 108 and the lessee resource profile 116 disclosed for resale, and compares them with the stored owner resource profile and, if there is a change, reflect the change including the time slot size change, and then grants the control of the shared resource to the final lessee. The control of the shared resource of the time slot authentication and authorization device 112 is collectively locked for each generated time slot at the time of initial use by the lessee so that the user of the corresponding time slot only can control the resource. Therefore, when the time slot is locked by the lessee, even the owner cannot control the shared resource. The only way to obtain control right in an emergency is to separate the physical locking device 114 and the time slot authentication and authorization device 112, and then install and newly set a new time slot authentication and authorization device 112. In addition, this time slot locking is asymmetric key encryption, and is realized with a private key that only known to the time slot-based lessee certificate 108 and the lessee.

In step 2F0, when the time slot of the lessee is automatically expired after a specified time by a standard time clock or timer included in the time slot authentication and authorization device 112, access of the lessee is electronically blocked. Since such an electronic blocking action may cause a safety accident in a shared resource that have power or is movable, it is necessary to continually inform the current lessee in use of the expiration point of the time slot in advance.

What is claimed is:

1. A resource sharing method implemented by a computer, comprising:
generating, by an owner, a sharing target resource profile that lists shared processing attribute data items including the size of a time slot that for the shared resource sets a sharing method, a sharing period of time, and a minimum sharing time unit;
generating, by the owner, a time slot based on the resource profile;
disclosing, by the owner, a generated owner certificate, resource profile, and shared time slots of the shared resource to a shared resource transaction system;
searching for, by a lessee, the resource profile and shared time slot;
verifying, by the lessee, the owner certificate and shared time slot to verify the safety of the shared resource transaction;
digitally signing, by the lessee, a share-use time slot purchase request including the owner certificate, resource profile, and purchase target time slots using a lessee certificate for charged or free, and then generating a shared resource right of use certificate and a time slot right of use;
receiving, by the lessee, the shared resource by electronic means using the shared resource right of use certificate and the time slot right of use;
repeating, by the lessee, opening and locking the time slot of the shared resource by electronic means using the time slot right of use;
electronically blocking access of the lessee after a specified time;
if the owner permits resale to the lessee, generating a sharing target resource profile for resale that lists shared processing attribute data items including the size of a time slot for resale that sets a sharing method, a sharing period of time, and a minimum sharing time unit, based on the time slot right of use held, with the same method as the owner to the extent not exceeding the range specified in the owner's shared resource profile;
generating, by the lessee, a time slot based on the resource profile for resale; and
disclosing, by the lessee, the generated owner certificate, resource profile, and shared time slots of the shared resource to the shared resource transaction system;
